(19) United States
(12) Patent Application Publication
(10) Pub. No.: US 2023/0183927 A1
(43) Pub. Date: Jun. 15, 2023

(54) METHODS FOR SEALING CRACKS AND EXPANSION JOINTS

(71) Applicants: Asphalt Materials Inc., Indianapolis, IN (US); Adventus Material Strategies, LLC, Daniel Island, SC (US)

(72) Inventors: Marvin Keller Exline, Terre Haute, IN (US); Todd W. Thomas, Indianapolis, IN (US); Joseph Lorenc, Daniel Island, SC (US); Andrew Jacob Eicher, Carmel, IN (US)

(73) Assignees: Asphalt Materials, Inc., Indianapolis, IN (US); Adventus Material Strategies, LLC, Daniel Island, SC (US)

(21) Appl. No.: 18/167,277

(22) Filed: Feb. 10, 2023

Related U.S. Application Data
(63) Continuation of application No. PCT/US21/45473, filed on Aug. 11, 2021.
(60) Provisional application No. 63/064,243, filed on Aug. 11, 2020.

(51) Int. Cl. E01C 11/00; E01C 7/14; E01C 11/06; E01C 11/10; C09J 5/02

(52) U.S. Cl. CPC E01C 11/005; E01C 7/147; E01C 11/06; E01C 11/103; C09J 5/02; C09J 2429/00; C09J 2431/00; C09J 2495/00

(57) ABSTRACT

Methods for sealing cracks and expansion joints comprising the use of an adhesion promoter. In certain embodiments, the adhesion promoter comprises a vinyl polymer.

### CROSS REFERENCE TO RELATED APPLICATION

This application is a continuation of International Application No. PCT/US2021/045473 filed Aug. 11, 2021, which claims the benefit of priority to U.S. Provisional Patent Application No. 63/064,243 filed on Aug. 11, 2020, each of which are hereby incorporated herein by reference in their entirety.

### BACKGROUND

Joints or cracks, e.g., space between cement or asphalt concrete slabs that make up areas such as the surface of bridges and roadways, typically require filling to create a smooth, uninterrupted surface and prevent against air and water intrusion that can cause deterioration of the slabs. These joints and cracks are characterized by having a trough-like structure with two sides and a bottom, wherein the trough is filled with a sealing material. Conventional materials for sealing expansion joints cracks in both asphalt and concrete pavements include hot and cold applied bituminous mastics, rubber compounds, coal tars, asphalts, silicones, urethanes and various combinations of these materials with and without minerals fillers and polymers. While these materials are designed to create a solid mass within the trough to prohibit intrusion of air and water, oftentimes these materials fail to appropriately adhere to the bottom and sides of the crack or joint. This can ultimately lead to intrusion of water and air in between the bottom and sides of the crack or joint and the mass of bituminous sealing material. Consequently, temperature and seasonal cycles can ultimately result in the failure and loss of the sealing material. Accordingly, there remains a need to develop joint and crack adhesion promoters to appropriately bind the sealing mass to the sides and bottom of the crack or joint.

### SUMMARY

The present disclosure relates methods comprising: identifying a crack or joint in an asphalt cement or concrete cement, wherein said crack or joint comprises a bottom and two sides; and applying an adhesion promoter to the bottom and sides of the crack or joint. In some embodiments, the adhesion promoter comprises a vinyl polymer, which can help enhance bonding of a subsequent sealing material applied inside the crack or joint. In certain embodiments, the vinyl polymer may be modified with one or more vinyl polymer modifiers, such as boric acid.

### DETAILED DESCRIPTION

For the purposes of promoting an understanding of the principles of the present disclosure, reference will now be made to certain embodiments and specific language will be used to describe the same. It will nevertheless be understood that no limitation of the scope of the disclosure is thereby intended, such alterations and further modifications, and such further applications of the principles of the disclosure as described herein being contemplated as would normally occur to one skilled in the art to which the disclosure relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

The present disclosure relates methods comprising: identifying a crack or joint in an asphalt cement or concrete cement, wherein said crack or joint comprises a bottom and two sides; and applying an adhesion promoter to the bottom and sides of the crack or joint. In some embodiments, the crack or expansion joint is associated with those found on bridges or roadways, either during construction or subsequent repairs. In some embodiments, the adhesion promoter comprises a vinyl polymer, which can help enhance bonding of a subsequent sealing material applied inside the crack or joint. Exemplary vinyl polymers include, but are not limited to, polyvinyl alcohol and polyvinyl acetate. In certain embodiments, the vinyl polymer may be modified with one or more vinyl polymer modifiers, such as boric acid.

In some embodiments, the surfaces of the sides and bottom of the crack or joint may be covered with particles or dust (aka, “fines). These fines, in turn, can prevent proper adhesion of a sealing material (e.g., bituminous binder) to the bottom and sides of the crack or joint. Thus, in certain embodiments, the methods described herein comprise the disposition of an adhesion promoter comprising a vinyl polymer to help effect bonding of the sealing material to the sides and bottom of the crack or joint. Without being bound to any particular theory, in certain embodiments Applicant has found that the vinyl polymer can penetrate (or neutralize the surface energy of) the fines and/or “bite” into the asphalt or concrete cement within the crack or joint, while bonding to sealing material subsequently applied, thereby increasing the adhesion of the sealing material to the sides and, optionally, the bottom of the crack or joint. In certain embodiments, application of the adhesion promoter is focused specifically on the sides of the crack or joint, which helps prevent “drooping” and retreat of the solidified sealing material in the crack or joint. It is believed, in certain embodiments, that the vinyl polymer aids in the immobilization of fines on the substrate, thereby permitting the overlying sealing material to bond to the insides of the crack or joint via the adhesion promoter. In certain embodiments, the adhesion promoter containing a vinyl polymer may comprise an aqueous composition. In certain embodiments, the vinyl polymer comprises about 0.1 to about 10 wt. % of the adhesion promoter composition, such as about 0.5 to about 5 wt. %, or about 1 to about 2 wt. %. In certain embodiments, the adhesion promoter is administered to the surface of the substrate by a distributor (e.g., manual or vehicle sprayer) at a rate of about 0.001 to about 0.20 gallons/yard², such as about 0.005 to about 0.15 or about 0.01 to about 0.10 gallons/yard². In certain embodiments, the adhesion promotor composition may further comprise one or more adhesion promoter additives, such as boric acid.

In certain embodiments, the sealing material comprises at least one of a bituminous material, a resinous material, a synthetic oil, or a bio-based oil. In certain embodiments, the sealing material comprises a hot or cold applied bituminous mastic, a rubber compound, a coal tar, a silicone, a urethane, an asphalt (e.g., emulsions), or some other combination of these materials, with and without minerals fillers and polymers. In certain embodiments, the sealing material comprises one or more components selected from an asphalt material, an elastomeric polymer, and a wax. In certain embodiments, the elastomeric polymer is selected from a styrene-butadiene-styrene polymer, an ethylene-styrene interpolymer, an isoprene polymer, a styrene-butadiene rubber, and an ethylene terpolymer. In certain embodiments, the wax is selected from a vegetable wax, an animal wax, a coal wax, a petroleum wax, an amide wax, or a waxy fatty acid soap. In certain embodiments, the sealing material comprises at least one of sulfur or a filler. Exemplary fillers include, but are not limited to, crumb rubber, fumed silica, and fumed alumina.

The uses of the terms “a” and “an” and “the” and similar references in the context of describing the disclosure (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the present disclosure has been illustrated and described in detail in the drawings and the foregoing description, the same is to be considered as illustrative and not restrictive in character, it being understood that only the preferred embodiment has been shown and described and that all changes and modifications that come within the spirit of the disclosure are desired to be protected. In addition, all references cited herein are indicative of the level of skill in the art and are hereby incorporated by reference in their entirety.

### EMBODIMENTS

The following provides an enumerated listing of some of the embodiments disclosed herein. It will be understood that this listing is non-limiting, and that individual features or combinations of features (e.g., 2, 3 or 4 features) as described in the Detailed Description above can be incorporated with the below-listed Embodiments to provide additional disclosed embodiments herein.

1. A method comprising:
identifying a crack or joint in an asphalt cement or concrete cement, wherein said crack or joint comprises a bottom and two sides; and
applying an adhesion promoter to the sides of the crack or joint.

2. The method of embodiment 1, further comprising filling the crack or joint with a sealing material.

3. The method of embodiment 2, wherein the sealing material comprises a bituminous material.

4. The method of any one of embodiments 1 to 3, wherein the adhesion promoter comprises a vinyl polymer.

5. The method of embodiment 4, wherein the vinyl polymer is selected from polyvinyl alcohol and polyvinyl acetate.

6. The method of any one of embodiments 2 to 5, wherein the sealing material comprises a bituminous binder.

7. The method of embodiment 6, wherein the sealing material further comprises at least one component selected from an asphalt material, an elastomeric polymer, or a wax.

8. The method according to any one of embodiments 1-7, wherein the adhesion promoter comprises an aqueous composition.

9. The method according to embodiment 8, wherein the adhesion promoter comprises a vinyl polymer.

10. The method of embodiment 9, wherein the vinyl polymer comprises about 0.1 to about 10 wt. % of the composition.

11. The method of embodiment 9, wherein the vinyl polymer comprises about 0.5 to about 5 wt. % of the composition.

12. The method of embodiment 9, wherein the composition is applied at a rate of about 0.001 to about 0.20 gallons/yard².

13. The method of any one of embodiments 4-12, wherein the vinyl polymer is modified with boric acid.

1. A method comprising:
identifying a crack or joint in an asphalt cement or concrete cement, wherein said crack or joint comprises a bottom and two sides; and
applying an adhesion promoter to the sides of the crack or joint.

2. The method of claim 1, further comprising filling the crack or joint with a sealing material.

3. The method of claim 2, wherein the sealing material comprises a bituminous material.

4. The method of claim 1, wherein the adhesion promoter comprises a vinyl polymer.

5. The method of claim 4, wherein the vinyl polymer is selected from polyvinyl alcohol and polyvinyl acetate.

6. The method of claim 2, wherein the sealing material comprises a bituminous binder.

7. The method of claim 6, wherein the sealing material further comprises at least one component selected from an asphalt material, an elastomeric polymer, or a wax.

8. The method according to claim 1, wherein the adhesion promoter comprises an aqueous composition.

9. The method according to claim 8, wherein the adhesion promoter comprises a vinyl polymer.

10. The method of claim 9, wherein the vinyl polymer comprises about 0.1 to about 10 wt. % of the composition.

11. The method of claim 9, wherein the vinyl polymer comprises about 0.5 to about 5 wt. % of the composition.

12. The method of claim 9, wherein the composition is applied at a rate of about 0.001 to about 0.20 gallons/yard².

13. The method of claim 4, wherein the vinyl polymer is modified with boric acid.
